(19) United States
(12) Patent Application Publication
(10) Pub. No.: US 2021/0017992 A1
(43) Pub. Date: Jan. 21, 2021

(54) ELECTRIC COMPRESSOR

(71) Applicant: LG Electronics Inc., Seoul (KR)

(72) Inventors: Junghoon PARK, Seoul (KR); Honghee PARK, Seoul (KR); Bunjune SEO, Seoul (KR); Jinyong JANG, Seoul (KR)

(73) Assignee: LG Electronics Inc., Seoul (KR)

(21) Appl. No.: 16/704,518

(22) Filed: Dec. 5, 2019

(30) Foreign Application Priority Data
Jul. 19, 2019 (KR) 10-2019-0087859

(51) Int. Cl. F04C 29/00; F04C 18/02

(52) U.S. Cl. CPC F04C 29/0042; F04C 18/0215; F04C 2240/56; F04C 2240/52; F04C 2240/40

(57) ABSTRACT

The present disclosure relates to an electrical compressor, comprising a housing, a compression part, a motor part, a first journal bearing coupled between a frame and a rotating shaft, a second journal bearing coupled between an eccentric part and an orbit scroll, and a ball bearing coupled to another end of the rotating shaft. The compression part comprises a fixed scroll disposed at an internal side of the housing, an orbit scroll configured to compress a refrigerant while orbiting the fixed scroll, and a frame configured to support the fixed scroll. The motor part comprises a rotating shaft comprising an eccentric part coupled to the orbit scroll at one end thereof, a stator disposed at another internal side of the housing, and a rotor rotatably disposed with respect to the stator and configured to rotate around the rotating shaft.

### CROSS-REFERENCE TO RELATED APPLICATION

This application claims the benefit of priority under 35 U.S.C. § 119(a) to Korean Patent Application No. 10-2019-0087859, filed on Jul. 19, 2019, the disclosure of which is incorporated herein by reference in its entirety.

### BACKGROUND

### 1. Technical Field

The present disclosure relates to a scroll-type electric compressor driven by a motor.

### 2. Background

As is well known, an electric compressor comprises a housing, a compression part provided inside the housing for compressing a refrigerant, and a motor for providing a driving force to the compression part.

In the compression part, a scroll compression type suitable for operating at a high compression ratio is widely used. The compression part of the scroll compression type compressor comprises a fixed scroll and an orbit scroll that allows the refrigerant to be compressed while orbiting with respect to the fixed scroll.

A rotating shaft of the motor is provided with an eccentric part, and the orbit scroll is provided with a boss part so that the eccentric part may be coupled thereto.

Both sides of the rotating shaft are rotatably supported by a main bearing and a sub-bearing, respectively.

The main bearing is provided between one end of the rotating shaft and a frame. The other end of the rotating shaft is provided with the sub-bearing.

An eccentric bearing is provided between the eccentric part and the boss part of the orbit scroll.

The main bearing, the sub-bearing, and the eccentric bearing are implemented as ball bearings.

As is well known, the ball bearing comprises an outer ring, an inner ring disposed to be concentrically spaced apart from an inside of the outer ring, and a plurality of balls provided between the outer ring and the inner ring.

However, in such a conventional scroll type electric compressor, since the main bearing, the sub-bearing, and the eccentric bearing are all implemented as ball bearings, there is a problem that a manufacturing cost is increased and an entire weight is increased.

In addition, in the conventional scroll type electric compressor, since the main bearing, the sub-bearing, and the eccentric bearing are all implemented as ball bearings, there is a problem that vibration and noise are increased.

### PRIOR ART DOCUMENT

### Patent Document

(Patent Document 1) KR1020160097883 A

### SUMMARY

Therefore, the present disclosure is directed to providing an electrical compressor capable of supporting a rotating shaft in radial and axial directions and suppressing an occurrence of vibration and noise.

In addition, the present disclosure is directed to providing an electrical compressor capable of reducing a weight and reducing a manufacturing cost.

Further, the present disclosure is directed to providing an electrical compressor capable of suppressing an occurrence of damage of a ball bearing when a rotating shaft and a ball bearing are coupled to each other.

Furthermore, the present disclosure is directed to providing an electrical compressor capable of suppressing an occurrence of damage of a ball bearing when a ball bearing and a ball bearing coupling part are coupled to each other.

In an electric compressor according to the present disclosure for solving the problems as described above, a journal bearing may be disposed at an end portion of a rotating shaft on a compression part side so as to enable a support in a radial direction, and a ball bearing may be disposed at an end portion of the rotating shaft on a motor side so as to enable a support in radial and axial directions, respectively.

Specifically, a motor part may be provided at one side of the compression part, a first journal bearing may be provided between a frame of the compression part and the rotating shaft, a second journal bearing may be disposed between one end portion of the rotating shaft and an orbit scroll of the compression part, a ball bearing may be provided at the other end portion of the rotating shaft, and thus not only the rotating shaft may be supported in the radial direction when the rotating shaft is rotated, but also the rotating shaft may be supported in the axial direction. In addition, an occurrence of vibration and noise may be reduced by the first journal bearing and the second journal bearing. Further, an entire weight may be reduced by the first journal bearing, the second journal bearing, and the ball bearing, and a manufacturing cost may be reduced.

The electric compressor may comprise a housing, a compression part, a motor part, a first journal bearing coupled between a frame and a rotating shaft, a second journal bearing coupled between an eccentric part and an orbit scroll, and a ball bearing coupled to another end of the rotating shaft. The compression part may comprise a fixed scroll disposed at an internal side of the housing, an orbit scroll configured to compress a refrigerant while orbiting the fixed scroll, and a frame configured to support the fixed scroll. The motor part may comprise a rotating shaft comprising an eccentric part coupled to the orbit scroll at one end thereof, a stator disposed at another internal side of the housing, and a rotor rotatably disposed with respect to the stator and configured to rotate around the rotating shaft.

The electric compressor may further comprise a ball bearing coupling part to which the ball bearing is coupled.

The ball bearing coupling part may be formed at the housing.

The ball bearing coupling part may be formed to open the housing, and formed at an inverter (inverter housing) coupled to block an opening of the housing.

The ball bearing may be press-fitted and coupled to the ball bearing coupling part.

The ball bearing may be configured such that the rotating shaft is coupled to the ball bearing when the ball bearing is coupled to the ball bearing coupling part.

The electric compressor may further comprise an inner ring support unit configured to support an inner ring of the ball bearing when the rotating shaft and the ball bearing are coupled to each other.

The inner ring support unit may be detachably coupled to the ball bearing coupling part.

The inner ring support unit may comprise a body, a rotating shaft accommodating part configured to be cut such that the rotating shaft is accommodated at one end of the body, and an inner ring contact part formed at both sides of the rotating shaft accommodating part and configured to be in contact with the inner ring of the ball bearing.

An inner ring support unit coupling part may be disposed at the ball bearing coupling part, and the inner ring support unit may be inserted and coupled to the inner ring support unit coupling part along a radial direction.

The ball bearing coupling part may be configured to communicate with an outer space of the ball bearing coupling part by the inner ring support unit coupling part. Accordingly, the refrigerant outside the ball bearing coupling part may flow via the inside of the ball bearing coupling part.

Cooling and lubrication of the ball bearing coupled inside the ball bearing coupling part may be facilitated (increased) by the refrigerant.

The housing may further comprise an intake port configured to suck the refrigerant.

The inner ring support unit may be configured to the inner ring support unit coupling part via the intake port.

The inner ring support unit coupling part may be formed on an extension line of the intake port.

Meanwhile, the ball bearing coupling part may comprise an inner ring support part in contact with an inner ring of the ball bearing. The inner ring support part may be configured to support the inner ring of the ball bearing when the rotating shaft and the ball bearing are coupled to each other.

The ball bearing coupling part may be recessed along an axial direction.

The inner ring support part may be configured to protrude in an axial direction from a recessed lower portion surface of the ball bearing coupling part.

For example, the inner ring support part may be formed in a circular ring shape.

For example, the inner ring support part may have an arc shape, and may be configured to be spaced apart from each other along the circumferential direction on the same circumference.

An inner surface of the inner ring support part may be disposed outside an inner surface of the inner ring with respect to a center of the rotating shaft.

An outer surface of the inner ring support part may be disposed between the inner ring and an outer ring of the ball bearing.

A communication part may be arranged to pass through the ball bearing coupling part such that an inside of the ball bearing coupling part and an outside of the ball bearing coupling part are configured to communicate with each other.

Accordingly, the refrigerant may flow into the inner ring support part.

The cooling and lubrication of the ball bearing may be further facilitated by the refrigerant flowed into the inner ring support part.

Meanwhile, the electric compressor may further comprise a ball bearing support unit inserted between the ball bearing and the ball bearing coupling part and configured to support the ball bearing.

The ball bearing may be coupled to the ball bearing coupling part after being coupled to the rotating shaft.

When the ball bearing is inserted, the ball bearing support unit may be in contact with the outer ring of the ball bearing and may be plastically deformable by a coupling force of the ball bearing.

Here, the ball bearing support unit may be formed of a soft material having a lower hardness (strength) as compared with a material of the ball bearing (outer ring) and a material of the ball bearing coupling part, for example, a nonferrous metal material.

The ball bearing support unit may be configured to have a cylindrical shape.

The ball bearing support unit may comprise a cylindrical-shaped body and a plurality of protrusions recessed from an outer surface and protruding inward along a radial direction of the body.

A long length of the plurality of protrusions may extend in an axial direction, respectively.

Meanwhile, according to another field of the present disclosure, an electric compressor may comprise a housing, a compression part, a motor part, a first journal bearing coupled between the frame and the rotating shaft, a ball bearing coupled to another end of the rotating shaft, and a ball bearing coupling part. The compression part may comprise a fixed scroll disposed at an internal side of the housing, an orbit scroll configured to compress a refrigerant while orbiting the fixed scroll, and a frame configured to support the fixed scroll. The motor part may comprise a rotating shaft comprising an eccentric part coupled to the orbit scroll at one end thereof, a stator disposed at another internal side of the housing, and a rotor rotatably disposed with respect to the stator and configured to rotate around the rotating shaft. The ball bearing may be press-fitted and coupled to the ball bearing coupling part.

In addition, according to another field of the present disclosure, an electric compressor may comprise a housing, a compression part, a motor part, a ball bearing coupled to the other end of the rotating shaft, a ball bearing coupling part, and an inner ring support unit configured to support an inner ring of the ball bearing when the rotating shaft is inserted and coupled to the inner ring of the ball bearing. The compression part may comprise a fixed scroll disposed at an internal side of the housing, an orbit scroll configured to compress a refrigerant while orbiting the fixed scroll, and a frame configured to support the fixed scroll. The motor part may comprise a rotating shaft comprising an eccentric part coupled to the orbit scroll at one end thereof, a stator disposed at another internal side of the housing, and a rotor rotatably disposed with respect to the stator and configured to rotate around the rotating shaft. The ball bearing may be press-fitted and coupled to the ball bearing coupling part. The inner ring of the ball bearing may be coupled inside the ball bearing coupling part.

As described above, according to one embodiment of the present disclosure, a journal bearing may be disposed at an end portion of a rotating shaft on a compression part side and a ball bearing may be disposed at the other end portion of the rotating shaft so as to be supported, and thus it may be possible to support the rotating shaft in both radial and axial directions, and an occurrence of vibration and noise may be suppressed.

In addition, a journal bearing having a low weight and a low manufacturing cost may be disposed at an end portion on the compression part side having a relatively high load, and thus a weight may be reduced and a manufacturing cost may be reduced.

Further, when the rotating shaft is inserted into the ball bearing in a state in which the ball bearing is coupled to a ball bearing coupling part, an inner ring of the ball bearing may be supported, thereby suppressing an occurrence of damage to the ball bearing.

Furthermore, an inner ring support unit in contact with the inner ring of the ball bearing to support the inner ring may be provided in the ball bearing coupling part, thereby suppressing an occurrence of damage of the ball bearing.

In addition, an inner ring support unit coupling part to which the inner ring support unit is detachably coupled may be arranged to pass through the ball bearing coupling part, and thus a refrigerant may flow into the ball bearing coupling part, and cooling and lubrication of the ball bearing may be promoted by the introduced refrigerant.

Further, an inner ring support part for supporting the inner ring may be formed inside the ball bearing coupling part, thereby suppressing an occurrence of damage of the ball bearing when the rotating shaft and the ball bearing are coupled to each other.

Furthermore, a ball bearing support unit inserted between the ball bearing coupling part and the ball bearing to support the ball bearing may be provided, thereby suppressing an occurrence of damage of the ball bearing while a clamping force between the ball bearing and the bearing coupling part is increased.

### BRIEF DESCRIPTION OF THE DRAWINGS

FIG. 1 is a cross-sectional view of an electric compressor according to an embodiment of the present disclosure.

FIG. 2 is an enlarged view of the ball bearing region of FIG. 1 according to an embodiment of the present disclosure.

FIG. 3 is a view illustrating a state in which an inner ring support unit is inserted into the inner ring support unit coupling part of FIG. 2 according to an embodiment of the present disclosure.

FIG. 4 is a plan view of the inner ring support unit of FIG. 3 according to an embodiment of the present disclosure.

FIG. 5 is a cross-sectional view taken along line V-V of FIG. 3 according to an embodiment of the present disclosure.

FIG. 6 is a cross-sectional view of an electric compressor according to an embodiment of the present disclosure.

FIG. 7 is an enlarged view of the ball bearing region of FIG. 6 according to an embodiment of the present disclosure.

FIG. 8 is a side view of the ball bearing coupling part of FIG. 7 according to an embodiment of the present disclosure.

FIG. 9 is a cross-sectional view taken along line IX-IX of FIG. 7 according to an embodiment of the present disclosure.

FIG. 10 is an enlarged view illustrating a main part of FIG. 9 according to an embodiment of the present disclosure.

FIG. 11 is a modified example of the ball bearing coupling part of FIG. 8 according to an embodiment of the present disclosure.

FIG. 12 is a cross-sectional view of an electric compressor according to an embodiment of the present disclosure.

FIG. 13 is an enlarged view of the ball bearing region of FIG. 12 according to an embodiment of the present disclosure.

FIG. 14 is a perspective view of the ball bearing support unit of FIG. 12 according to an embodiment of the present disclosure.

FIG. 15 is a side view of the ball bearing support unit of FIG. 14 according to an embodiment of the present disclosure.

FIG. 16 is a cross-sectional view taken along line XVI-XVI of FIG. 15 according to an embodiment of the present disclosure.

FIG. 17 is a view for describing a process of inserting the ball bearing of FIG. 12 according to an embodiment of the present disclosure.

FIG. 18 is a modified example of the ball bearing support unit of FIG. 12 according to an embodiment of the present disclosure.

### DETAILED DESCRIPTION

Hereinafter, embodiments of the present disclosure will be described in detail with reference to the accompanying drawings. Herein, like reference numerals denote like elements even in different embodiments, and a description for an element appearing first will replace descriptions for like elements appearing later. As used herein, the singular forms “a,” “an,” and “the” are intended to include the plural forms as well unless the context clearly indicates otherwise. In describing embodiments disclosed in the specification, moreover, the detailed description will be omitted when a specific description for publicly known technologies to which the disclosure pertains is judged to obscure the gist of the embodiments disclosed in the specification. Also, it should be noted that the accompanying drawings are merely illustrated to easily understand the embodiments disclosed in the specification, and therefore, they should not be construed to limit the technical spirit disclosed in the specification.

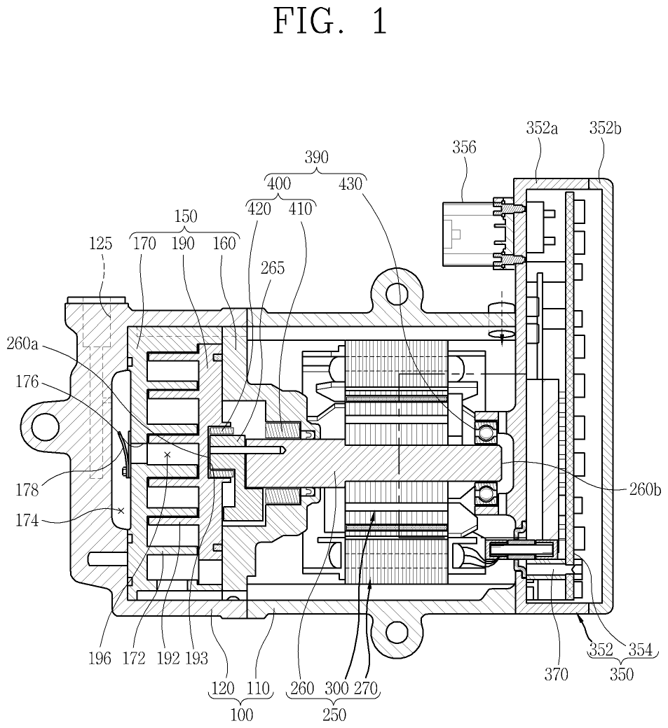

FIG. 1 is a cross-sectional view of an electric compressor according to an embodiment of the present disclosure. As shown in FIG. 1, the electric compressor of the present embodiment may comprise a housing 100, a compression part 150, and a motor part 250. In the electric compressor of the present embodiment, an electric compressor using a refrigerant 134a is illustrated as an example, but it is merely illustrative, and the present embodiment is not limited thereto.

The housing 100 may form a sealed accommodating space therein. The housing 100 may comprise a main housing 110 and a rear housing 120. In the present embodiment, for example, the housing 100 may be installed in a horizontal direction in drawings, in which the main housing 110 may be disposed in the front (right side in the drawing) and the rear housing 120 may be disposed in the rear (left side in the drawing).

For example, the main housing 110 may be implemented in a cylindrical shape. For example, both sides of the main housing 110 may be formed so as to be open. The rear housing 120 may have a shape in which one side is opened. The main housing 110 and the rear housing 120 may be coupled to be in face contact with each other along an axial direction to form a sealed accommodating space therein.

For example, the compression part 150 and the motor part 250 may be disposed inside the housing 100 so as to be spaced apart along the axial direction. More specifically, for example, the motor part 250 may be disposed inside the main housing 110, and the compression part 150 may be disposed inside the rear housing 120.

An intake port 115 into which the refrigerant is sucked may be formed at one side of the housing 100 (main housing 110). An exhaust port 125 through which the compressed refrigerant inside is discharged may be formed at another side of the housing 100 (rear housing 120).

The refrigerant sucked via the intake port 115 may be moved to the compression part 150 via the motor part 250. The refrigerant moved to the compression part 150 and sucked inside the compression part 150 may be compressed to be discharged to the outside of the compression part 150, and may be discharged to the outside of the housing 100 via the exhaust port 125.

An inverter part 350 may be provided at one side (front) of the main housing 110. For example, the inverter part 350 may be configured such that a power may be converted into a high frequency AC power to be provided to the motor part. More specifically, for example, the inverter part 350 may be configured to be connected to a battery (not shown) of a vehicle and convert a DC power supplied from the battery into an AC power to provide it to the motor part. The inverter part 350 may comprise an inverter housing 352 and a printed circuit board 354 provided inside the inverter housing 352. For example, the inverter housing 352 may comprise an inverter housing body 352a in which one side is opened and a cover 352b for opening and closing the opening of the inverter housing body 352a.

For example, the inverter housing 352 may be coupled so as to block the opening (front opening) of the housing 100 (main housing 110). A connector 356 may be provided at one side of the inverter housing 352. The connector 356 may be connected to one side of the printed circuit board 354 so as to enable signal transmission.

An electric conduction part 370 may be provided between the inverter part 350 and the motor part 250. The electric conduction part 370 may be configured such that the inverter part 350 and the motor part 250 are electrically connected to each other. One end portion of the electric conduction part 370 may be connected to the printed circuit board 354, and the other end portion thereof may be connected to the motor part 250. Accordingly, the electric conduction part 370 may transmit a power and/or a control signal of the inverter part 350 to the motor part 250. The electric conduction part 370 may be configured to be airtightly coupled such that leakage of fluid inside the housing 100 may be suppressed.

In the present embodiment, a case in which one end portion (front end portion in the drawing) of the main housing 110 is configured to be open, and the inverter housing 352 is configured to block a front opening of the main housing 110 is illustrated, but it is merely illustrative, and the main housing 110 may be configured in a shape in which the front end is blocked.

The compression part 150 may comprise a frame 160, a fixed scroll 170 fixed to the frame 160, and an orbit scroll 190 disposed between the frame 160 and the fixed scroll 170.

The frame 160 may have a disk shape. The frame 160 may be fixed to the housing 100.

The fixed scroll 170 may be fixedly supported by the frame 160. A fixing lap 172 having an involute shape may be provided at one surface of the fixed scroll 170. A discharge chamber 174 may be formed at the other side of the fixed scroll 170. A discharge port 176 through which the refrigerant compressed by the fixing lap 172 is discharged may be formed passing through the fixed scroll 170. A check valve 178 may be provided at the discharge port 176. The check valve 178 may be provided at the discharge chamber 174.

The orbit scroll 190 may be orbitably disposed between the frame 160 and the fixed scroll 170. An orbit lap 192 interacting with the fixing lap 172 to compress the refrigerant may be provided at one side of the orbit scroll 190. The orbit lap 192 may have an involute shape corresponding to the fixing lap 172. Accordingly, a compression chamber 196 for sucking and compressing the refrigerant may be formed between the fixing lap 172 and the orbit lap 192. The compression chamber 196 may communicate with the discharge chamber 174 by the discharge port 176. An eccentric part coupling part 193 in which an eccentric part 265 of a rotating shaft 260 of the motor part 250 to be described later is accommodated may be formed at the other side of the orbit scroll 190. The eccentric part coupling part 193 may be formed to be recessed along a thickness direction of the orbit scroll 190.

The motor part 250 may comprise a rotating shaft 260 having one end connected to the compression part 150, a stator 270 provided in the housing 100, and a rotor 300 that is rotatably disposed with an air gap G with respect to the stator 270.

The stator 270 may comprise a stator core 272 comprising a plurality of slots and teeth and a stator coil 282 wound around a slot of the stator core 272. For example, the stator core 272 may be formed by insulating and laminating a plurality of electric steel plates 274. The stator coil 282 may be connected to the electric conduction part 370 to receive a power and control signal. For example, the stator coil 282 may be configured so as to be driven by a three-phase AC power source.

For example, the rotor 300 may comprise a rotor core 302 rotating around the rotating shaft 260 and a plurality of permanent magnets 312 provided at the rotor core 302. For example, the rotor core 302 may be formed by insulating and laminating a plurality of electric steel plates. A rotating shaft hole 306 may be formed passing through a center of the rotor core 302 such that the rotating shaft 260 may be inserted. A permanent magnet insertion part 308 may be formed passing through the rotor core 302 such that the permanent magnet 312 may be inserted along an axial direction. The permanent magnet insertion part 308 may be formed to be close to a circumference of the rotor core 302. The permanent magnet insertion part 308 may be formed to be spaced apart from each other along the circumferential direction of the rotor core 302. A plurality of penetration portions 310 passing through the rotor core 302 in the axial direction may be formed.

In the present embodiment, a case in which the rotor 300 is implemented as a synchronous rotor including a plurality of permanent magnets 312 is illustrated, but it is merely illustrative and the present disclosure is not limited thereto. The rotor 300 may be implemented as an induction rotor including the rotor core 302 and a plurality of conduction bars (not shown) inserted into the rotor core 302 in the axial direction.

Meanwhile, both end portions of the rotating shaft 260 may be rotatably supported by a bearing 390. The rotating shaft 260 may be configured to be supported by two journal bearings 400 and one ball bearing 430.

The journal bearing 400 may be provided at one end portion of the rotating shaft 260 (end portion 260a on compression part side). The journal bearing 400 may have a cylindrical shape. Bearing surfaces may be provided on the inside and the outside of the journal bearing 400, respectively. Accordingly, an occurrence of vibration and noise may be suppressed, as compared with the configuration in which the rotating shaft 260 is supported by the ball bearing when the rotating shaft 260 rotates. In addition, since the journal bearing 400 may be less in number of parts and may be easier to manufacture than the ball bearing in structure, a weight may be reduced and a manufacturing cost may be reduced.

The journal bearing 400 may comprise a first journal bearing 410 disposed between the rotating shaft 260 and the frame 160. The first journal bearing 410 may have a cylindrical shape. Bearing surfaces may be formed at inner and outer surfaces of the first journal bearing 410, respectively.

The journal bearing 400 may comprise a second journal bearing 420 disposed between the eccentric part 265 and the orbit scroll 190. The second journal bearing 420 may have a cylindrical shape. Bearing surfaces may be formed at inner and outer surfaces of the second journal bearing 420, respectively.

A ball bearing 430 may be provided at the other end portion of the rotating shaft 260 (end portion 260b on motor part side). According to such a configuration, the rotating shaft 260 may support in both the radial and axial directions. Accordingly, gaps in both radial and axial directions of the rotating shaft 260 may be suppressed.

Since the end portion 260b on the motor part side of the rotating shaft 260 may have a relatively small load as compared with the end portion 260a on the compression part side, the ball bearing 430 may be configured to have a relatively small size. Accordingly, a size and weight of the ball bearing 430 may be reduced. In addition, a manufacturing cost of the ball bearing 430 may be reduced.

In addition, the end portion 260b on the motor part side of the rotating shaft 260 may be configured to be supported by the ball bearing 430, and thus a manufacturing cost of the rotating shaft 260 may be reduced and a manufacturing time may be shortened as compared with a conventional case in which the end portion 260b on the motor part side of the rotating shaft 260 is configured to be supported by the journal bearing. More specifically, when the journal bearing is provided at the end portion 260b on the motor part side, in order to lubricate the journal bearing, an oil supply path passing through a center of the rotating shaft 260 in the axial direction may be formed such that oil in a region of the end portion 260a on the compression part side may be moved to the end portion 260b on the motor part side. In case of the present disclosure, since the end portion 260b on the motor part side may be supported by the ball bearing 430, it may not be necessary to process the oil supply path passing through the shaft center of the rotating shaft 260, and thus the manufacturing cost of the rotating shaft 260 may be reduced and the manufacturing time may be shortened.

The electric compressor may comprise a ball bearing coupling part 450 to which the ball bearing 430 may be coupled. For example, the ball bearing coupling part 450 may be formed at the inverter housing 352. In the embodiment, a case in which the ball bearing coupling part 450 is formed at the inverter housing 352 is illustrated, but it is merely illustrative and the present disclosure is not limited thereto. More specifically, when the front opening of the housing 100 (main housing 110) is configured to be blocked, the ball bearing coupling part 450 may be formed in the housing 100 (main housing 110).

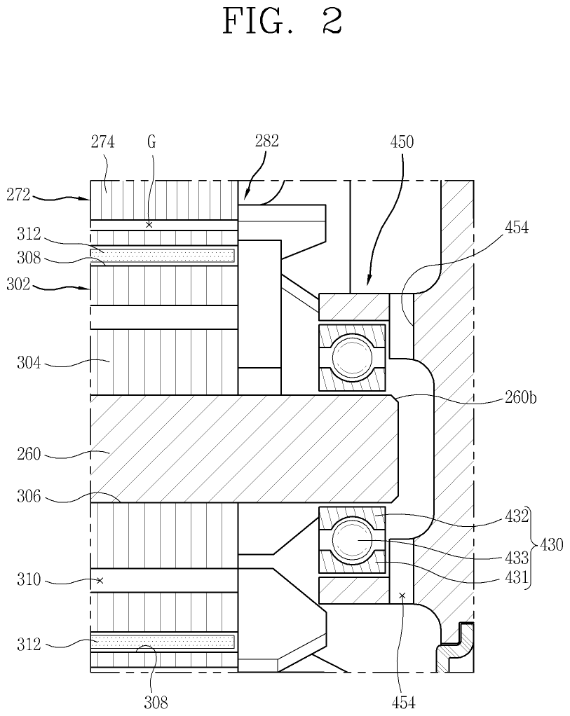

FIG. 2 is an enlarged view of the ball bearing region of FIG. 1 according to an embodiment of the present disclosure. As shown in FIG. 2, the ball bearing 430 may comprise an outer ring 431, an inner ring 432, and a plurality of balls 433. The outer ring 431 and the inner ring 432 may be disposed to be spaced apart along the radial direction and concentrically with each other. The plurality of balls 433 may be provided between the outer ring 431 and the inner ring 432. Grooves in which the plurality of balls 433 are partially accommodated respectively may be formed at an inner surface of the outer ring 431 and an outer surface of the inner ring 432, respectively.

The ball bearing coupling part 450 may be formed such that the ball bearing 430 may be inserted in the axial direction. For example, the ball bearing coupling part 450 may be formed in a cylindrical shape having one side opened along the axial direction. For example, the ball bearing coupling part 450 may be in contact with the outer ring 431 and may be formed with an outer ring support part 452 for supporting the outer ring 431 in the axial direction. The outer ring support part 452 may be formed to protrude along the radial direction and to extend along the circumferential direction from an inner surface of the ball bearing coupling part 450.

In the embodiment, the ball bearing 430 may be configured to be press-fitted and coupled into the ball bearing coupling part 450. The ball bearing 430 may be coupled to the rotating shaft 260 after being press-fitted and coupled into the ball bearing coupling part 450. The rotating shaft 260 and the ball bearing 430 may be press-fitted and coupled to each other.

The electric compressor of the present embodiment may comprise an inner ring support unit 460 to be described later for supporting the inner ring 432 of the ball bearing 430 when the rotating shaft 260 and the ball bearing 430 are coupled to each other. Accordingly, when the rotating shaft 260 and the ball bearing 430 are coupled to each other, an occurrence of damage of the ball bearing 430 may be suppressed.

An inner ring support unit coupling part 454 to which the inner ring support unit 460 is coupled may be formed at the ball bearing coupling part 450. The inner ring support unit coupling part 454 may be formed passing through the ball bearing coupling part 450 along the radial direction.

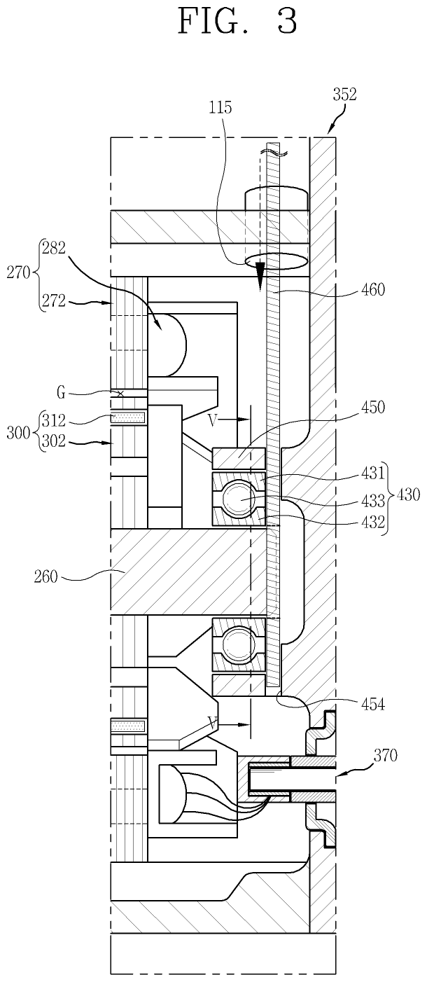

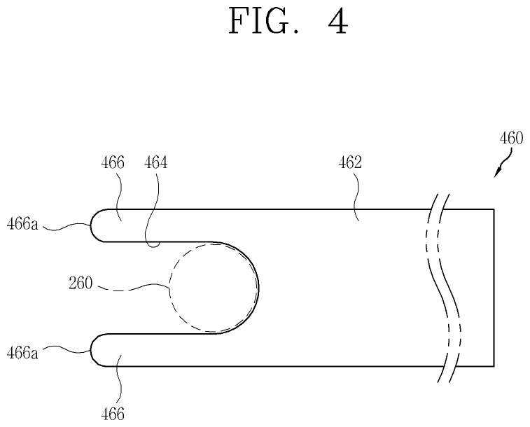

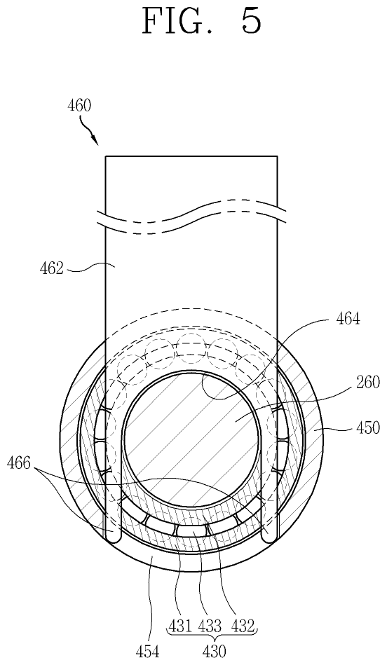

FIG. 3 is a view illustrating a state in which an inner ring support unit is inserted into the inner ring support unit coupling part of FIG. 2, FIG. 4 is a plan view of the inner ring support unit of FIG. 3, and FIG. 5 is a cross-sectional view taken along line V-V of FIG. 3. As shown in FIGS. 3 to 5, the inner ring support unit 460 may be coupled to the ball bearing coupling part 450. For example, the inner ring support unit 460 may be configured to enable insertion and withdrawal via the intake port 115 of the housing 100.

The inner ring support unit coupling part 454 may be formed to be disposed on an extension line of the intake port 115. Accordingly, the inner ring support unit 460 may be inserted and withdrawn via the intake port 115 more easily.

As shown in FIG. 4, the inner ring support unit 460 may comprise a body 462, a rotating shaft accommodating part 464 to be cut such that the rotating shaft 260 is accommodated at one end of the body 462, and an inner ring contact part 466 formed at both sides of the rotating shaft accommodating part 464 to be in contact with the inner ring of the ball bearing 430.

The body 462 may be configured to have an approximately rectangular plate shape having a width corresponding to an outer diameter of the inner ring 432 and a long length as compared with the width. Here, the length of the body 462 may be formed such that the end portion of the body 462 may be exposed to the outside of the intake port 115 in a state of being coupled to the ball bearing coupling part 450.

The body 462 may be configured to have a sufficient thickness such that a support strength capable of being in contact with the inner ring 432 to support the inner ring 432 may be provided when the rotating shaft 260 is press-fitted and coupled into the inner ring 432.

The rotating shaft accommodating part 464 may be formed to be cut so as to have a width corresponding to a diameter of the rotating shaft 260 such that the rotating shaft 260 may be accommodated.

For example, the inner ring contact part 466 may comprise arc-shaped end portions 466a having an arc shape, respectively. Accordingly, when the inner ring support unit 460 is inserted, interference between the inner ring contact part 466 and the inner ring support unit coupling part 454 may be suppressed, and the insertion may be performed smoothly.

According to such a configuration, the ball bearing 430 may be press-fitted into the ball bearing coupling part 450. The end portion 260a on the compression part side of the rotating shaft 260 may be coupled to the orbit scroll 190 and the frame 160, respectively via the second journal bearing 420 and the first journal bearing 410 before the ball bearing 430 is coupled to the end portion 260b on the motor part side.

As shown in FIGS. 3 and 5, the inner ring support unit 460 may be inserted and coupled into the inner ring support unit coupling part 454 via the intake port 115. The inner ring support unit 460 may be in contact with an end portion of a front side (right end portion in drawings) of the ball bearing 430.

When the end portion 260b on the motor part side of the rotating shaft 260 is contacted and pressurized to an inlet of the inner ring 432 of the ball bearing 430, the end portion 260b on the motor part side of the rotating shaft 260 may be press-fitted into the inner ring 432. At this point, as shown in FIG. 5, the inner ring 432 may be in contact with and supported by the inner ring contact part 466 of the inner ring support unit 460, thereby suppressing damage of the ball bearing 430.

The end portion 260b on the motor part side of the rotating shaft 260, which may be completely coupled to the inner ring 432, may protrude from the inner ring 432 to be inserted into the rotating shaft accommodating part of the inner ring support unit 460.

When the rotating shaft 260 is completely coupled, the inner ring support unit 460 may be removed to the outside of the housing 100 via the intake port 115.

Meanwhile, when operating the electric compressor of the present embodiment, a part of the refrigerant sucked via the intake port 115 may flow via the inside of the ball bearing coupling part 450 through the inner ring support unit coupling part 454. The refrigerant flowed into the ball bearing coupling part 450 may be in contact with the ball bearing 430, and thus cooling and lubrication of the ball bearing 430 may be facilitated. Accordingly, forced wear of the ball bearing 430 may be suppressed and service life may be extended.

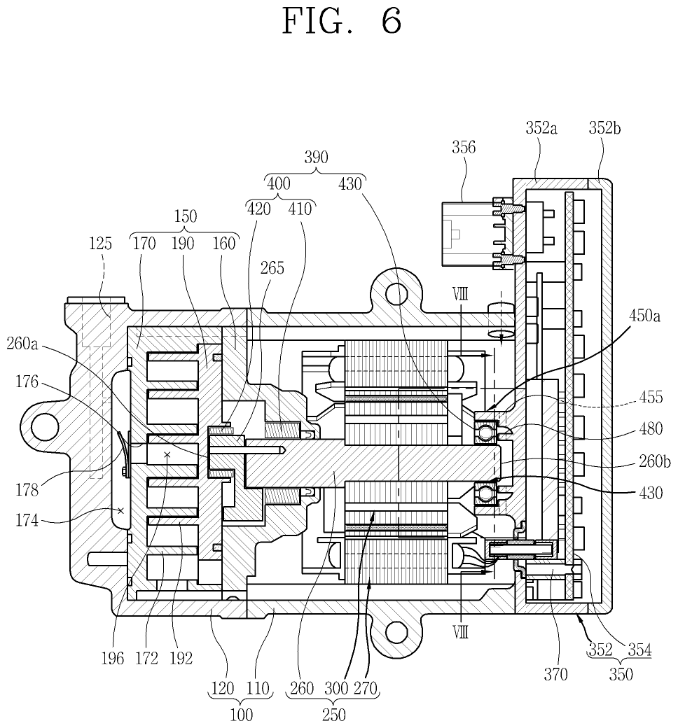

Hereinafter, another embodiment of the present disclosure will be described with reference to FIGS. 6 to 14.

FIG. 6 is a cross-sectional view of an electric compressor according to another embodiment of the present disclosure. As shown in FIG. 6, the electric compressor of the present embodiment may comprise a housing 100, a compression part 150, and a motor part 250.

The housing 100 may comprise a main housing 110 and a rear housing 120 that may be coupled to each other to form a sealed accommodating space therein.

An inverter part 350 may be provided at a front end portion of the main housing 110.

The motor part 250 may be disposed inside the main housing 110.

The compression part 150 may be provided inside the rear housing 120.

The compression part 150 may comprise a frame 160, a fixed scroll 170 and an orbit scroll 190.

The motor part 250 may comprise a rotating shaft 260 having one end portion coupled to the orbit scroll 190, a stator 270, and a rotor 300 rotatably coupled to the stator 270 around the rotating shaft 260.

Meanwhile, both end portions of the rotating shaft 260 may be rotatably supported by a bearing 390. The rotating shaft 260 may be configured to be supported by two journal bearings 400 and one ball bearing 430.

The journal bearing 400 may be provided at an end portion 260a on the compression part side of the rotating shaft 260, and the ball bearing 430 may be provided at an end portion 260b on the motor part side of the rotating shaft 260. Accordingly, the journal bearing 400 may be disposed at the end portion on the compressor side having a relatively high load, thereby suppressing an occurrence of vibration and noise. In addition, the journal bearing may be simple in configuration and easy to manufacture, as compared with the ball bearing 430, and thus a weight thereof may be reduced and a manufacturing cost may be reduced.

In addition, the ball bearing 430 may be provided at the end portion 260b on the motor part side of the rotating shaft 260 having a relatively small load, and thus a support in radial and axial directions of the rotating shaft 260 may be enabled, simultaneously. Since the ball bearing 430 may be configured to support a relatively small load, the ball bearing 430 may be configured to be relatively small in size, and thus a weight thereof may be reduced and a manufacturing cost may be reduced.

More specifically, a first journal bearing 410 may be provided between the rotating shaft 260 and the frame 160. The first journal bearing 410 may have a cylindrical shape. Accordingly, an occurrence of vibration and noise of the rotating shaft 260 may be suppressed.

A second journal bearing 420 may be provided between an eccentric part 265 of the rotating shaft 260 and a coupling part of the orbit scroll 190. The second journal bearing 420 may have a cylindrical shape. Accordingly, an occurrence of vibration and noise may be suppressed when the rotating shaft 260 rotates.

A ball bearing 430 may be provided at the end portion 260b on the motor part side of the rotating shaft 260. As described above, the ball bearing 430 may comprise an outer ring 431, an inner ring 432 disposed to be concentrically spaced apart from the inside of the outer ring 431, and a plurality of balls 433 provided between the outer ring 431 and the inner ring 432.

The electric compressor of the present embodiment may comprise a ball bearing coupling part 450a for supporting the ball bearing 430.

For example, the ball bearing coupling part 450a may be formed at the inverter housing 352. In the present embodiment, a case in which the front end portion of the housing 100 is formed to be open, and the inverter housing 352 is coupled such that the front end portion of the housing 100 is blocked to form the ball bearing coupling part 450a at the inverter housing 352 is illustrated, but it is merely illustrative, and when the front end portion of the housing 100 is configured in a blocked shape, the ball bearing coupling part 450a may be formed at the housing 100.

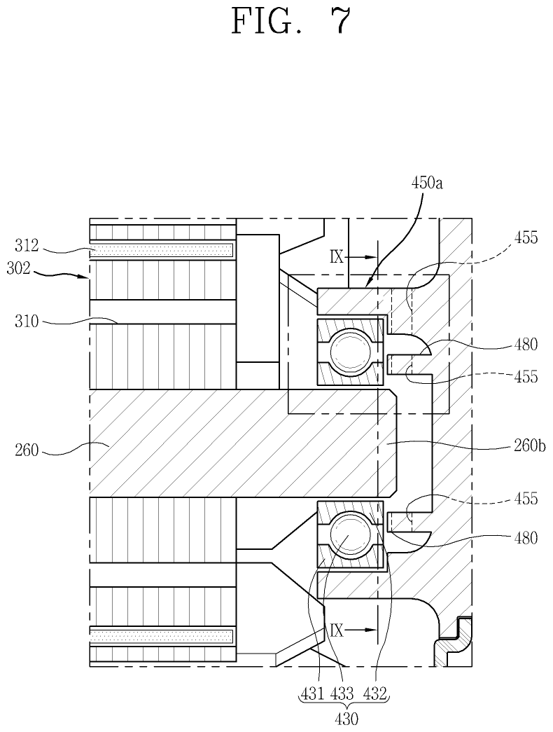

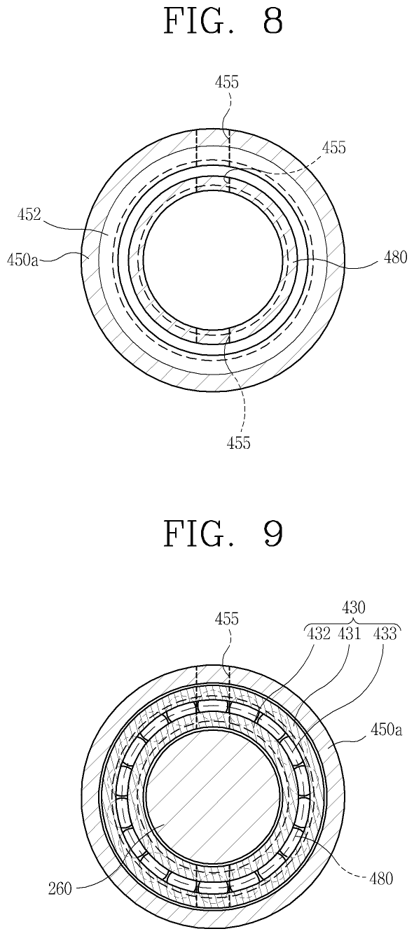

FIG. 7 is an enlarged view of the ball bearing region of FIG. 6, and FIG. 8 is a cross-sectional view taken along line VIII-VIII of FIG. 7. As shown in FIGS. 7 and 8, the ball bearing coupling part 450a may be formed to be open in the axial direction. The ball bearing coupling part 450a may be implemented in a cylindrical shape. For example, the ball bearing coupling part 450a may comprise an outer ring support part 452 in contact with the outer ring 431 to support the outer ring 431 in the axial direction when the ball bearing 430 is coupled. For example, the outer ring support part 452 may be implemented in a shape protruding along the radial direction and extending along the circumferential direction from an inner surface of the ball bearing coupling part 450a.

Meanwhile, an inner ring support part 480 in contact with the inner ring 432 to support the inner ring 432 may be provided at the ball bearing coupling part 450a. Accordingly, an occurrence of damage of the ball bearing 430 may be suppressed when the rotating shaft 260 and the inner ring 432 are coupled to each other.

The inner ring support part 480 may be formed to protrude in the axial direction from a recessed lower portion surface of the ball bearing coupling part 450a. For example, the inner ring support part 480 may be formed in a circular ring (ring) shape. A communication part 455 may be formed at the ball bearing coupling part 450a such that the inside and the outside thereof are communicated with each other. The communication part 455 may be formed passing through the ball bearing coupling part 450a along the radial direction. Accordingly, the refrigerant outside the ball bearing coupling part 450a may flow into the ball bearing coupling part 450a. Cooling and lubrication of the ball bearing 430 coupled to the ball bearing coupling part 450a may be facilitated by the refrigerant flowed into the ball bearing coupling part 450a. Accordingly, forced wear of the ball bearing 430 may be suppressed and service life may be extended.

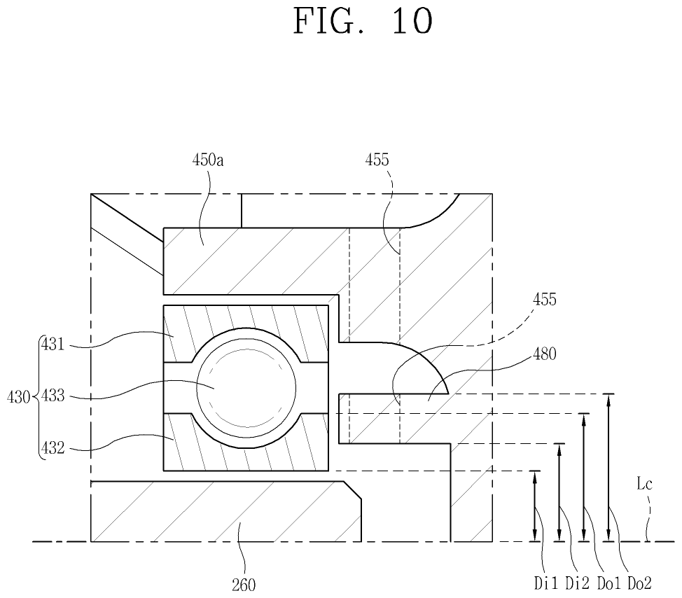

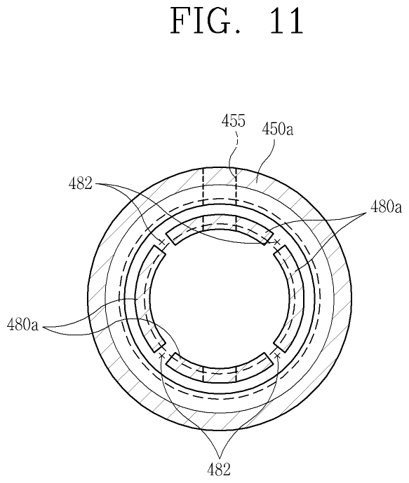

FIG. 9 is a cross-sectional view taken along line IX-IX of FIG. 7, FIG. 10 is an enlarged view illustrating a main part of FIG. 9, and FIG. 11 is a modified example of the ball bearing coupling part of FIG. 8. As shown in FIGS. 9 and 10, the inner ring support part 480 may be configured to be in contact with the inner ring 432 of the ball bearing 430 coupled to the inner portion of the ball bearing coupling part 450a so as to support the inner ring 432. Accordingly, when the inner ring 432 of the ball bearing 430 is pressurized in the axial direction, a movement of the inner ring 432 in the axial direction may be limited, and an occurrence of damage of the ball bearing 430 may be suppressed.

As shown in FIG. 10, the inner ring support part 480 may be formed such that an inner surface thereof is more spaced apart than an inner surface of the inner ring 432 with respect to a center line Lc of the rotating shaft 260. An inner diameter of the inner ring support part 480 may be formed to be larger than that of the inner ring 432. Accordingly, interference between the rotating shaft 260 and the inner ring support part 480 may be suppressed.

The inner ring support part 480 may be formed such that an outer surface thereof is the same as or more spaced apart than an outer surface of the inner ring 432 based on the center line Lc of the rotating shaft 260. The inner ring support part 480 may be formed such that the outer surface thereof is disposed between the inner ring 432 and the outer ring 431 of the ball bearing 430. An outer diameter of the inner ring support part 480 may be formed to be larger than that of the inner ring 432. Accordingly, a support strength of the inner ring support part 480 may be increased. In the present embodiment, a case in which the outer diameter of the inner ring support part 480 is formed to be larger than that of the inner ring 432 is illustrated, but it is merely illustrative, and the outer diameter of the inner ring support part 480 may be formed to be the same as that of the inner ring support part 480.

FIG. 11 is a modified example of the ball bearing coupling part of FIG. 8. As shown in FIG. 11, the ball bearing coupling part 450a of the electric compressor of the present embodiment may have a cylindrical shape in which one side is opened along the axial direction. An outer ring support part 452 for supporting the outer ring 431 of the ball bearing 430 may be provided inside the ball bearing coupling part 450a. A communication part 455 that communicates with the inside and the outside thereof may be provided at the ball bearing coupling part 450a. The communication part 455 may be formed passing through the ball bearing coupling part 450a along the radial direction. The communication part 455 may be open toward the intake port 115 of the housing 100.

Meanwhile, an inner ring support part 480a in contact with the inner ring 432 of the ball bearing 430 to support the inner ring 432 in the axial direction may be formed inside the ball bearing coupling part 450a.

The inner ring support part 480a may be formed to protrude in the axial direction from a recessed lower portion surface of the ball bearing coupling part 450a.

For example, the inner ring support part 480a may be configured to be spaced apart along the circumferential direction in plural.

For example, the inner ring support part 480a may be configured to have an arc-shaped cross section.

An inner diameter of the inner ring support part 480a may be formed to be larger than that of the inner ring 432.

An outer diameter of the inner ring support part 480a may be formed to be larger than that of the inner ring 432.

A gap 482 may be formed between inner ring support parts 480a adjacent to each other. Accordingly, the inside and the outside of the inner ring support part 480a may communicate with each other along the radial direction.

According to such a configuration, the ball bearing 430 may be press-fitted and coupled into the ball bearing coupling part 450a. When the ball bearing 430 is inserted, the outer ring 431 may be contacted by the outer ring support part 452, and the inner ring 432 may be contacted and supported by the inner ring support part 480a.

When the ball bearing 430 is completely coupled, the end portion 260b on the motor part side of the rotating shaft 260 may be contacted to the inlet of the inner ring 432 of the ball bearing 430 and pressurized in the axial direction. At this point, the outer ring 431 and the inner ring 432 of the ball bearing 430 may be supported by the outer ring support part 452 and the inner ring support part 480a, respectively, and thus an occurrence of damage of the ball bearing 430 may be suppressed when the rotating shaft 260 is press-fitted.

Meanwhile, when the electric compressor of the present embodiment is driven, a refrigerant may be sucked into the housing 100 via the intake port 115. A part of the refrigerant sucked into the housing 100 may be flowed via the inner portion of the ball bearing coupling part 450a through the communication part 455.

The refrigerant flowed into the ball bearing coupling part 450a may be flowed into an inner space of the inner ring support part 480a via the gap 482 formed between the inner ring support parts 480a.

The refrigerant flowed into the ball bearing coupling part 450a and the inner ring support part 480a may be in contact with the ball bearing 430, and thus cooling and lubrication of the ball bearing 430 may be facilitated. Accordingly, forced wear of the ball bearing 430 may be suppressed and the service life may be extended.

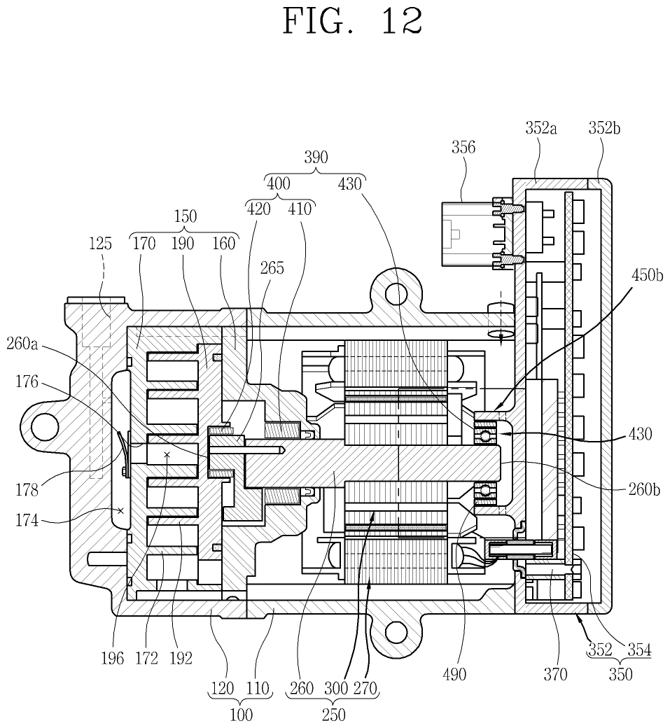

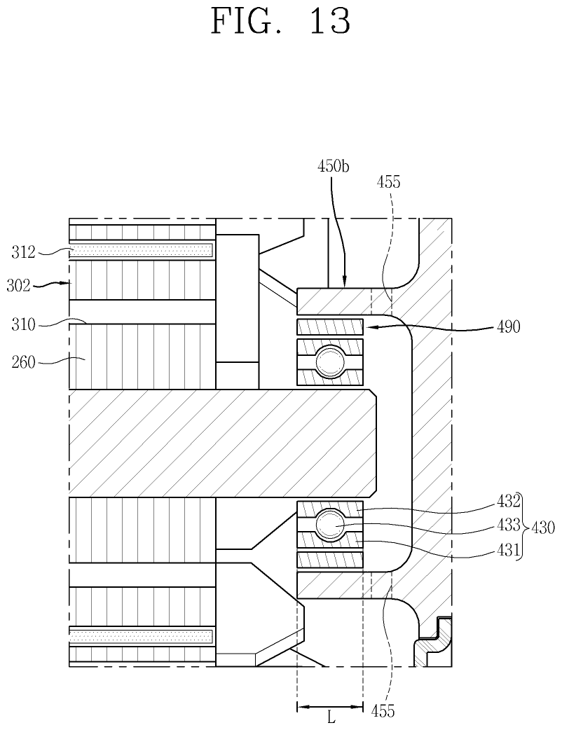

FIG. 12 is a cross-sectional view of an electric compressor according to still another embodiment of the present disclosure, and FIG. 13 is an enlarged view of the ball bearing region of FIG. 12. As shown in FIG. 12, the electric compressor of the present embodiment may comprise a housing 100, a compression part 150, and a motor part 250.

The housing 100 may comprise a main housing 110 and a rear housing 120. An inverter part 350 may be provided in the front of the main housing 110. An electric conduction part 370 may be provided between the inverter part 350 and the motor part 250.

The compression part 150 may be provided at the inside of the housing 100 (rear housing 120). The compression part 150 may comprise a frame 160, a fixed scroll 170 and an orbit scroll 190.

The motor part 250 may be provided at the inside of the housing 100 (main housing 110). The motor part 250 may comprise a rotating shaft 260 having one end connected to the orbit scroll 190, a stator 270 fixed inside the housing 100, and a rotor 300 disposed to be spaced apart to have an air gap with respect to the stator 270 and rotating around the rotating shaft 260.

An eccentric part 265 may be provided at an end portion 260a on the compression part side of the rotating shaft 260. The eccentric part 265 may be coupled to a coupling part of the orbit scroll 190. Accordingly, when the rotating shaft 260 rotates, the orbit scroll 190 may orbit around the rotating shaft 260.

Meanwhile, both end portions of the rotating shaft 260 may be rotatably supported by the bearing 390. The rotating shaft 260 may be configured to be supported by two journal bearings 400 and one ball bearing 430.

The journal bearing 400 may be provided at the end portion 260a on the compression part side of the rotating shaft 260, and the ball bearing 430 may be provided at the end portion on the motor shaft side of the rotating shaft 260.

According to such a configuration, the journal bearing 400 may be provided at the end portion 260a on the compression part side of the rotating shaft 260 having a relatively large load, and thus an occurrence of vibration and noise may be suppressed when the rotating shaft 260 rotates. In addition, since the journal bearing 400 may be simple in configuration and easy to manufacture as compared with a ball bearing, a manufacturing cost may be reduced and a weight may be reduced, significantly.

Further, since the ball bearing 430 may be provided at the end portion 260b on the motor part side of the rotating shaft 260 having a relatively small load, a size of the ball bearing 430 may be relatively small, and thus a weight may be reduced and a manufacturing cost may be reduced.

The journal bearing 400 may have a cylindrical shape. Bearing surfaces may be formed at inner and outer surfaces of the journal bearing 400, respectively.

The journal bearing 400 may comprise a first journal bearing 410 provided between the rotating shaft 260 and the frame 160.

The journal bearing 400 may comprise a second journal bearing 420 provided between the eccentric part 265 and the orbit scroll 190.

The ball bearing 430 may comprise an outer ring 431, an inner ring 432 concentrically disposed at the inside of the outer ring 431, and a plurality of balls 433 provided between the outer ring 431 and the inner ring 432.

The electric compressor of the present embodiment may comprise a ball bearing coupling part 450b to which the ball bearing 430 may be coupled. For example, the ball bearing coupling part 450b may be formed at the inverter housing 352.

For example, the ball bearing coupling part 450b may have a cylindrical shape in which one side (inside) is opened along the axial direction.

The ball bearing coupling part 450b may be formed with a communication part 455 so as to communicate with the inside and outside thereof. The communication part 455 may be formed passing through the ball bearing coupling part 450b along the radial direction.

For example, the ball bearing 430 may be coupled to the ball bearing coupling part 450b after being coupled to the rotating shaft 260.

Meanwhile, the electric compressor of the present embodiment may be configured to further comprise a ball bearing support unit 490 inserted between the ball bearing 430 and the ball bearing coupling part 450b to support the ball bearing 430.

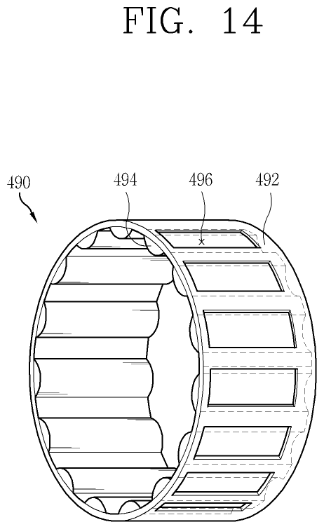

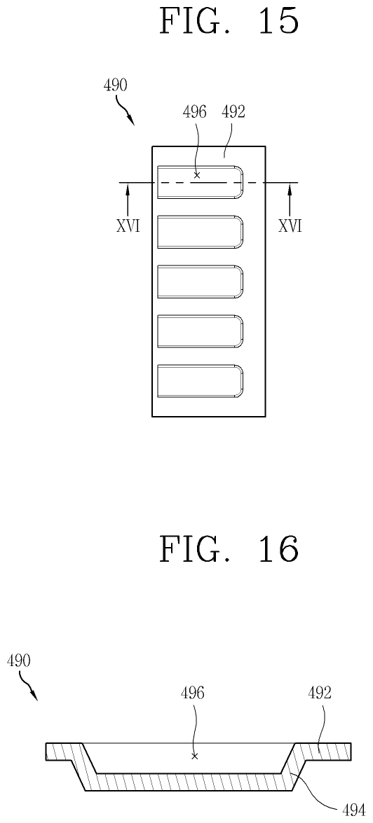

FIG. 14 is a perspective view of the ball bearing support unit of FIG. 12, FIG. 15 is a side view of the ball bearing support unit of FIG. 14, and FIG. 16 is a cross-sectional view taken along line XVI-XVI of FIG. 15. As shown in FIGS. 14 to 16, the ball bearing support unit 490 may have a cylindrical shape. For example, in the ball bearing support unit 490, the ball bearing 430 coupled to the rotating shaft 260 may be inserted into the ball bearing support unit 490 in a state of being inserted into the ball bearing coupling part 450b.

When the ball bearing 430 is inserted, the ball bearing support unit 490 may be in contact with the outer ring 431 of the ball bearing 430 so as to be formed plastically deformable by the coupling force of the ball bearing 430.

Here, the ball bearing support unit 490 may be formed of a soft material having a lower hardness (strength) as compared with a material of the ball bearing 430 (outer ring 431) and a material of the ball bearing coupling part 450b, for example, a nonferrous metal material. Accordingly, an occurrence of damage of the ball bearing 430 may be suppressed when the ball bearing 430 and the ball bearing coupling part 450b are coupled to each other.

The ball bearing support unit 490 may comprise a cylindrical-shaped body 492 and a plurality of protrusions 494 recessed from an outside and protruding inwardly along the radial direction of the body 492. For example, the body 492 may be configured to have the same length (height) L as the ball bearing 430 along the axial direction.

The ball bearing support unit 490 may be configured to have substantially the same height as that of the ball bearing 430 along the axial direction.

An inner diameter of the ball bearing support unit 490 may be formed to be the same as an outer diameter of the ball bearing 430 or larger than the outer diameter of the ball bearing 430.

An outer diameter of the ball bearing support unit 490 may be formed to be the same as or smaller than an inner diameter of the ball bearing coupling part 450b.

Recessed space portions 496 recessed from an outer surface of the body 492 may be formed at the outside of the plurality of protrusions 494, respectively.

An inner diameter of the plurality of protrusions 494 may be formed to be smaller than the outer diameter of the ball bearing 430.

The plurality of protrusions 494 may be formed to have a long length along the axial direction.

The plurality of protrusions 494 may be formed to have a long length as compared with the width thereof.

For example, the plurality of protrusions 494 may be formed to be closer to one end portion of the body 492.

For example, the plurality of protrusions 494 may be formed to be closer to a side end portion into which the ball bearing 430 is inserted.

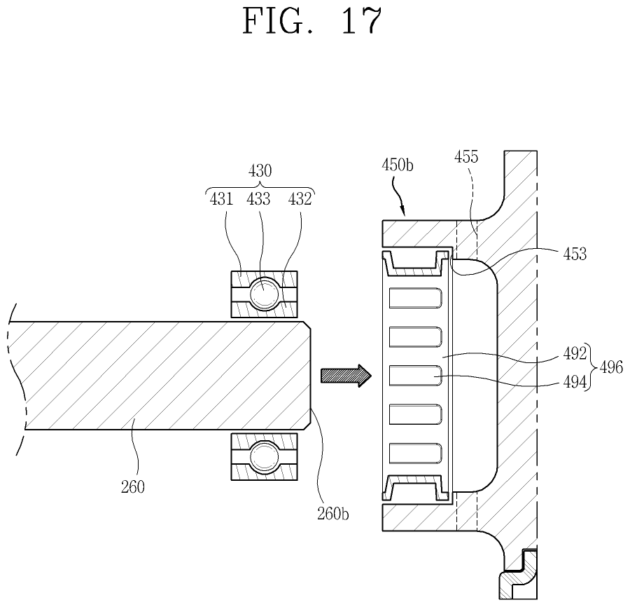

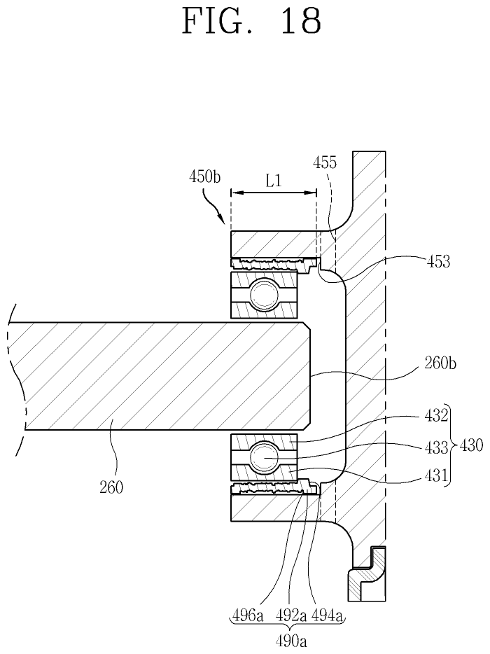

FIG. 17 is a view for describing a process of inserting the ball bearing of FIG. 12, and FIG. 18 is a modified example of the ball bearing support unit of FIG. 12. As shown in FIG. 17, the ball bearing support unit 490 may be inserted and coupled into the ball bearing coupling part 450b. A support portion 453 which may be in contact with the ball bearing support unit 490 to limit a movement of the ball bearing support unit 490 in the axial direction may be formed inside the ball bearing coupling part 450b. For example, the support portion 453 may be formed to protrude along the radial direction from an inner surface of the ball bearing coupling part 450b.

In a state in which the ball bearing support unit 490 is coupled to the inside of the ball bearing coupling part 450b, the ball bearing 430 coupled to the end portion 260b on the motor part side of the rotating shaft 260 may be inserted into the ball bearing coupling part 450b.

The rotating shaft 260 and the inner ring 432 of the ball bearing 430 may be first press-fitted and coupled before the ball bearing coupling part 450b is inserted.

When the ball bearing 430 press-fitted to the rotating shaft 260 is contacted and pressurized to the inlet of the ball bearing support unit 490, the outer ring 431 of the ball bearing 430 may be inserted into the ball bearing support unit 490. The ball bearing 430 inserted into the ball bearing support unit 490 may be in contact with the protrusion 494, and the protrusion 494 may be plastically deformed while opening toward the recessed space portion 496 of the outside thereof along the radial direction by the pressing force of the ball bearing 430. Accordingly, a fastening force of the ball bearing 430 and the ball bearing coupling part 450b may be increased.

Meanwhile, as shown in FIG. 18, a ball bearing support unit 490a may be configured to have a long length (height) L1 as compared with the length (height) L of the outer ring 431 along the axial direction. The ball bearing support unit 490a may comprise a body 492a and a plurality of protrusions 494a recessed from an outer surface and protruding from an inner surface of the body 492a. Recessed space portions 496a recessed from the outer surface of the body 492a may be formed at outsides of the plurality of protrusions 494a, respectively. According to such a configuration, after the ball bearing 430 is completely inserted into the ball bearing support unit 490a, a part of sections of the plurality of protrusions 494a may be maintained in their original shape without being plastically deformed, and thus a fastening force of the ball bearing 430 and the ball bearing coupling part 450b may be increased and a movement in the axial direction is limited, thereby further increasing a supporting force for the ball bearing 430.

When the rotating shaft 260 and the ball bearing 430 may be completely inserted, as shown in FIG. 18, a part of the protrusions 494a along the axial direction of rotating shaft 260 may not be plastically deformed outwardly along the radial direction, and may be in contact with an end portion of the outer ring 431 while maintaining an original shape to support the ball bearing 430 in the axial direction. Accordingly, as the plurality of protrusions 494a are plastically deformed along the radial direction, the ball bearing support unit 490a may increase the fastening force between the ball bearing 430 and the ball bearing coupling part 450b. In addition, a part of the plurality of protrusions 494a of the ball bearing support unit 490a may not be plastically deformed, and may be in contact with the end portion of the outer ring 431 of the ball bearing 430, and thus a movement in the axial direction of the ball bearing 430 may be suppressed.

In the foregoing, exemplary embodiments of the present disclosure have been shown and described. However, the present disclosure may be embodied in various forms without departing from the spirit or essential characteristics thereof, and accordingly, it is intended that the embodiment described above not be limited by the detailed description provided herein.

Moreover, even if any embodiment is not specifically disclosed in the foregoing detailed description, it should be broadly construed within the scope of the technical spirit, as defined in the accompanying claims. Furthermore, all modifications and variations included within the technical scope of the claims and their equivalents should be covered by the accompanying claims.

What is claimed is:

1. An electric compressor, comprising:
a housing;
a compression part comprising:
a fixed scroll and disposed at an internal side of the housing,
an orbit scroll configured to compress a refrigerant while orbiting the fixed scroll, and
a frame configured to support the fixed scroll;
a motor part comprising:
a rotating shaft comprising an eccentric part coupled to the orbit scroll at one end thereof,
a stator disposed at another internal side of the housing, and
a rotor rotatably disposed with respect to the stator and configured to rotate around the rotating shaft;
a first journal bearing coupled between the frame and the rotating shaft;
a second journal bearing coupled between the eccentric part and the orbit scroll; and
a ball bearing coupled to another end of the rotating shaft.

2. The electric compressor of claim 1, further comprising
a ball bearing coupling part,
wherein the ball bearing is press-fitted and coupled to the ball bearing coupling part.

3. The electric compressor of claim 2, wherein the rotating shaft is coupled to the ball bearing while the ball bearing is coupled inside the ball bearing coupling part, and
wherein the electric compressor further comprises an inner ring support unit configured to support an inner ring of the ball bearing when the rotating shaft and the ball bearing are coupled to each other.

4. The electric compressor of claim 3, wherein the inner ring support unit is detachably coupled to the ball bearing coupling part.

5. The electric compressor of claim 4, wherein the inner ring support unit comprises:
a body;
a rotating shaft accommodating part configured to be cut such that the rotating shaft is accommodated at one end of the body; and
an inner ring support part formed at both sides of the rotating shaft accommodating part and configured to support the inner ring of the ball bearing.

6. The electric compressor of claim 5, further comprising an inner ring support unit coupling part disposed at the ball bearing coupling part, wherein the inner ring support unit is inserted and coupled to the inner ring support unit coupling part along a radial direction.

7. The electric compressor of claim 6, wherein:
the housing comprises an intake port configured to suck a refrigerant, and
the inner ring support unit is coupled to the inner ring support unit coupling part via the intake port.

8. The electric compressor of claim 7, wherein the inner ring support unit coupling part is formed on an extension line of the intake port.

9. The electric compressor of claim 2, wherein the ball bearing coupling part comprises an inner ring support part in contact with an inner ring of the ball bearing, wherein the inner ring support part is configured to support the inner ring of the ball bearing when the rotating shaft and the ball bearing are coupled to each other.

10. The electric compressor of claim 9, wherein the inner ring support part is configured to protrude in an axial direction from a lower portion surface of the ball bearing coupling part.

11. The electric compressor of claim 10, wherein an inner surface of the inner ring support part is disposed outside an inner surface of the inner ring with respect to a center of the rotating shaft.

12. The electric compressor of claim 10, wherein an outer surface of the inner ring support part is disposed between the inner ring and an outer ring of the ball bearing.

13. The electric compressor of claim 10, wherein a communication part is arranged to pass through the ball bearing coupling part such that an inside of the ball bearing coupling part and an outside of the ball bearing coupling part are configured to communicate with each other.

14. The electric compressor of claim 2, wherein:
the ball bearing is configured to be coupled to the ball bearing coupling part after being coupled to the rotating shaft, and
the electric compressor further comprises a ball bearing support unit inserted between the ball bearing and the ball bearing coupling part and configured to support the ball bearing.

15. The electric compressor of claim 14, wherein, when the ball bearing is inserted, the ball bearing support unit is in contact with an outer ring of the ball bearing and is plastically deformable by a coupling force of the ball bearing.

16. The electric compressor of claim 15, wherein the ball bearing support unit has a cylindrical shape.

17. The electric compressor of claim 16, wherein the ball bearing support unit comprises a cylindrical-shaped body and a plurality of protrusions, wherein the plurality of protrusions are recessed from an outer surface and protrude inward along a radial direction of the body.

18. The electric compressor of claim 17, wherein a long length of the plurality of protrusions extends in an axial direction, respectively.

19. An electric compressor, comprising:
a housing;
a compression part comprising:
a fixed scroll disposed at an internal side of the housing,
an orbit scroll configure to compress a refrigerant while orbiting the fixed scroll, and
a frame configured to support the fixed scroll;
a motor part comprising:
a rotating shaft comprising an eccentric part coupled to the orbit scroll at one end thereof,
a stator disposed at another internal side of the housing, and
a rotor rotatably disposed with respect to the stator and configured to rotate around the rotating shaft;
a first journal bearing coupled between the frame and the rotating shaft;
a ball bearing coupled to another end of the rotating shaft; and
a ball bearing coupling part, wherein the ball bearing is press-fitted and coupled to the ball bearing coupling part.

20. An electric compressor, comprising:
a housing;
a compression part comprising:
a fixed scroll disposed at an internal side of the housing,
an orbit scroll configured to compress a refrigerant while orbiting the fixed scroll, and
a frame configured to support the fixed scroll;
a motor part comprising:
a rotating shaft comprising an eccentric part coupled to the orbit scroll at one end thereof,
a stator disposed at another internal side of the housing, and
a rotor rotatably disposed with respect to the stator and configured to rotate around the rotating shaft;
a ball bearing coupled to another end of the rotating shaft;
a ball bearing coupling part, wherein the ball bearing is press-fitted and coupled to the ball bearing coupling part; and
an inner ring support unit configured to support an inner ring of the ball bearing when the rotating shaft is inserted and coupled to the inner ring of the ball bearing, wherein the inner ring of the ball bearing is coupled inside the ball bearing coupling part.
